(19) United States
(12) Patent Application Publication
(10) Pub. No.: US 2006/0066132 A1
(43) Pub. Date: Mar. 30, 2006

(54) Transporting device with drag reduction dimples

(76) Inventor: John Splawn Page JR., Lake Forest, CA (US)

Correspondence Address: JOHN SPLAWN PAGE JR., 25092 FARTHING ST., APT# 122, LAKE FOREST, CA, 92630, US

(21) Appl. No.: 10/954,518

(22) Filed: Sep. 30, 2004

(51) Int. Cl. B62D 25/02

(52) U.S. Cl. 296/181.1

(57) ABSTRACT

A device that transports people or cargo or equipment that has an exterior surface that has a plurality of closely spaced apart dimple depressions on some or all its surfaces whereby they reduce the surface tension stickiness on said surfaces when said devise moves through water, air or on snow or ice.

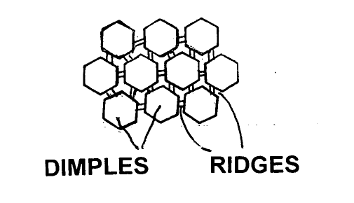

### BACKGROUND

This invention relates to the problem of surface tension drag and flow characteristics of air or water on the surfaces of aircraft, boats, automobiles, trains and missiles as they move through air or water. The drag and uneven flow of water and air slows the speed of a vehicle and affects the fuel consumption and the flying or driving range of a vehicle.

### PRIOR ART

When dimples were put on golf balls, their flight characteristics were improved and the distance was increased. This was the result of uniform smoother airflow around the ball.

### OBJECTS AND ADVANTAGES

The object and advantage and of this invention is to reduce fuel consumption on all kinds of vehicles and increase the flying or driving range of them. This is accomplished by producing vehicles that have their surfaces manufactured with dimple depressions and ridges between the dimples in their surfaces. This reduces the surface tension drag and spreads and smoothes the flow of water or air as it moves across a surface. The economic benefits of reduced fuel consumption could be substantial.

### SUMMARY OF THE INVENTION

Applicant believes his invention can make significant improvement in the speed of vehicles and or reduce fuel consumption of them by incorporating dimple depressions on the surfaces of said vehicles.

### OPERATION OF DIMPLES AND RIDGES

In water flow tests, there is the appearance that the dimples and ridges break the water molecules apart and spread them laterally and they lose their grip on the surface they move across. The result is a uniform surface tension reduction across a broad surface area.

### BRIEF DESCRIPTION OF DRAWINGS

Applicant's drawing illustrate the preferred hexagon design of the dimple depressions. Round dimples may also be used. If the round dimples are used, the rows should be staggered in order to keep the ridges between the holes uniform in width. It may require that different size dimple combinations be used to maintain uniform ridge widths.

### DETAILED DESCRIPTION

Applicant's flow test indicates that the hexagon shape is best. It has six sides equal in length. They are spaced next to each other, just close enough to leave a narrow ridge between them.

The dimples may be pressed into metal panels that are used on aircraft and vehicles. Synthetic sheets can be made with the dimples incorporated into their structure. The sheets may be applied with adhesives to some surfaces as a veneer. Some vehicles may use molds to form the shape of the desired parts with the dimples formed into their surface. Boat hulls may mold whole hulls with the dimples molded into the surface. Snow boards, sleds, water and snow skis, and the bottom of pontoons on seaplanes would also benefit.

1. A device that transports people or cargo or equipment that has an exterior surface that has a plurality of closely spaced apart dimple depressions on some or all of its surfaces.
